(19) United States
(12) Patent Application Publication
(10) Pub. No.: US 2026/0325393 A1
(43) Pub. Date: Oct. 22, 2026

(54) PULSATILE GLOVE FOR DIGIT PERFUSION

(71) Applicants: John E Gatti, Columbus, OH (US); John W Gatti, Baltimore, MD (US)

(72) Inventors: John E Gatti, Columbus, OH (US); John W Gatti, Baltimore, MD (US)

(21) Appl. No.: 19/649,783

(22) Filed: Apr. 16, 2026

Related U.S. Application Data
(60) Provisional application No. 63/789,519, filed on Apr. 16, 2025.

(51) Int. Cl. A61H 9/00

(52) U.S. Cl. CPC A61H 9/0078; A61H 2201/0103; A61H 2201/1635

(57) ABSTRACT

A device for promoting blood perfusion includes a covering, at least one bladder module, and a primary conduit. The bladder modules are disposed within digit portions of the covering and are in fluid communication with the primary conduit. The primary conduit is configured to be coupled to a fluid transfer device, which may be separate from, integrated with, or otherwise provided with the covering. Transfer of fluid, such as air, into the primary conduit is directed to the bladder modules, causing the bladder modules to inflate against the covering and apply positive pressure to a user's hand when the device is worn. Multiple bladder module configurations are disclosed.

### CROSS-REFERENCE TO RELATED APPLICATIONS

This is a nonprovisional application that claims the benefit of U.S. Provisional Application No. 63/789,519 filed Apr. 16, 2025, the disclosures of which are hereby incorporated by reference as if fully restated herein.

### TECHNICAL FIELD

The present invention relates generally to systems and methods for improving blood flow in the extremities of patients with extreme hypotension. And more particularly, to systems and methods for improving blood flow in the hands, feet, and digits thereof when poor perfusion from hypotension exists.

### BACKGROUND

During periods of extreme low blood pressure (hypotension) the digits are often deprived of oxygenated blood and suffer tissue injury. Low cardiac output associated with heart failure as a result of myocardial infarction, heart muscle injury after surgery, and other medical conditions may cause blood to be preferentially shunted to essential organs. These seriously ill patients may require vaso-active medications to increase blood pressure and blood flow. These powerful medications may further compromise the vascularity to less-essential organs. The extremities are often deprived of badly needed blood flow. The fingers and toes may totally loose circulation for extended periods of time suffering tissue necrosis and may ultimately require amputation.

Existing options to help the lack of blood flow into digits during these periods of extreme hypotension are rather limited. Warm compresses may be applied in hopes of causing vasodilation. However, heat increases the oxygen demand of tissues so tissue damaged may be increased. Nitroglycerin paste has been tried with minimal improvement and causes concern that nitroglycerin absorption could worsen systemic blood pressure, such that it is not used. Medication remedies or assistive devices to improve blood flow and reduce digit necrosis are unavailable.

Accordingly, those skilled in the art continue with research and development efforts in the field of promoting blood perfusion in the digits.

### SUMMARY OF THE INVENTION

Disclosed are devices for blood perfusion that include a covering, at least one bladder module, and a primary conduit.

In some embodiments, the covering includes a digit potion and defines an open interior space wherein a hand may be received. The bladder module is located within the digit portion of the covering and includes at least one bladder extending along at least a portion of a length of the digit module, along an inner surface thereof. The primary conduit extends between the exterior of the covering and the interior of the covering and is in fluid communication with the at least one bladder of the bladder module. The primary conduit defines a main opening that is couplable to a fluid transfer device. The covering supports the at least one bladder of the bladder module in operative engagement with a user's digit when the device is worn. Transfer of fluid into the covering via the primary conduit causes the at least one bladder to inflate against the covering and apply positive pressure to the digit.

In some embodiments, the bladder module includes a first bladder, a second bladder, and a connecting conduit. Each of the first bladder and the second bladder are elongated and arranged laterally along an inner surface of the digit portion. Each of the first bladder and the second bladder define a distal end and a proximal end. The proximal end of the first bladder is connected to the primary conduit, the connecting conduit is connected to the distal end of the first bladder and the distal end of the second bladder, and the proximal end of the second bladder is closed.

In some embodiments, the bladder module includes a first bladder, a second bladder, and a connecting conduit. Each of the first bladder and the second bladder is helical and arranged along an inner surface of the digit portion, extending along a length thereof, such that the first bladder and the second bladder coil around a digit when the device is worn. Each of the first bladder and the second bladder define a distal end and a proximal end. The proximal end of the first bladder is connected to the primary conduit, the connecting conduit is connected to the distal end of the first bladder and the distal end of the second bladder, and the proximal end of the second bladder is closed.

In some embodiments, the bladder module includes a plurality of circumferential bladders arranged in sequence along an inner surface of the digit portion, extending along a length thereof. The bladder module further includes a plurality of dedicated conduits, each separately and independently fluidly connected to a circumferential bladder. Each dedicated conduit is in fluid communication with the primary conduit, either directly or via a branching conduit.

In some embodiments, the covering includes a plurality of digit portions and a plurality of bladder modules, each located within a digit portion of the covering. The primary conduit ramifies into a plurality of branch conduits, each fluidly connected to a bladder module of the plurality of bladder modules.

In some embodiments, the covering is glove-shaped and configured to be worn on a hand.

In some embodiments, the covering is sock-shaped, having one or more digit portions, and configured to be worn on a foot.

In some embodiments, the bladder module is configured to apply pressure in a range of approximately 30 to 80 mmHg to a digit.

In some embodiments, the covering defines one or more fenestrations.

In some embodiments, the device further includes a battery-powered fluid transfer device operatively connected to the primary conduit via the main opening.

Other examples of the disclosed devices will become apparent from the following detailed description, the accompanying drawings and the appended claims.

### BRIEF DESCRIPTION OF THE DRAWINGS

Novel features and advantages of the present invention, in addition to those expressly mentioned herein, will become apparent to those skilled in the art from a reading of the following detailed description in conjunction with the accompanying drawings. The present disclosure is illustrated by way of example, and not by way of limitation, in the figures of the accompanying drawings. It should be noted that different references to “an” or “one” embodiment in this disclosure are not necessarily to the same embodiment, and such references mean at least one.

FIG. 1 is an illustration of the skeletal structure and vascular system of a human hand from a palmar perspective;

FIG. 2 is a top cross-sectional view of a first exemplary embodiment of the device;

FIG. 3 is a top exploded view of an exemplary embodiment of a bladder module;

FIG. 4 is a top view of the bladder module of FIG. 3;

FIG. 5 is a side view of the bladder module of FIG. 3 with a human finger;

FIG. 6 is a top view of the bladder module of FIG. 3 with a human finger;

FIG. 7 is a top cross-sectional view of a second exemplary embodiment of the device;

FIG. 8 is a top view of another exemplary embodiment of a bladder module with a human finger;

FIG. 9 is a side view of one of the bladders of the bladder module of FIG. 8 with a human finger;

FIG. 10 is a side view of yet another exemplary embodiment of a bladder module;

FIG. 11 is a side view of the bladder module of FIG. 10 with a human finger;

FIG. 12 is a top cross-sectional view of a third exemplary embodiment of the device.

### DETAILED DESCRIPTION OF EXEMPLARY EMBODIMENTS

As used herein, the term “distal extremities” refers to hands and feet.

The human hand is generally comprised of three main parts: the wrist, the palm, and the fingers.

As used herein, the term “palm” refers to the metacarpal region, i.e., the central mass of the hand, including the metacarpal bones and the surrounding musculature, connective tissue, and skin.

As used herein, the term “wrist” refers to the carpal region, i.e., the intermediate structure connecting the palm to the forearm, including the carpal bones and the surrounding musculature, connective tissue, and skin.

As used herein, the term “fingers” refers to the phalangeal regions of the hand, including the thumb, and encompasses the underlying skeletal structures (including the phalanges) as well as the associated musculature, connective tissue, and skin.

The human foot is generally comprised of three main parts: the hindfoot, midfoot, and forefoot.

As used herein, the term “hindfoot” refers to the posterior region of the foot, including the heel and ankle, and encompassing the underlying skeletal structures (including the calcaneus and talus) as well as the associated musculature, connective tissue, and skin.

As used herein, the term “midfoot” refers to the intermediate region of the foot between the hindfoot and forefoot, including the arch, and encompassing the underlying skeletal structures (including the navicular, cuboid, and cuneiform bones) as well as the associated musculature, connective tissue, and skin.

As used herein, the term “forefoot” refers to the anterior region of the foot, including the toes, and encompassing the underlying skeletal structures (including the metatarsals and phalanges) as well as the associated musculature, connective tissue, and skin.

As used herein, the term “digits” refers to the phalangeal regions of the hand and foot, including the fingers and toes.

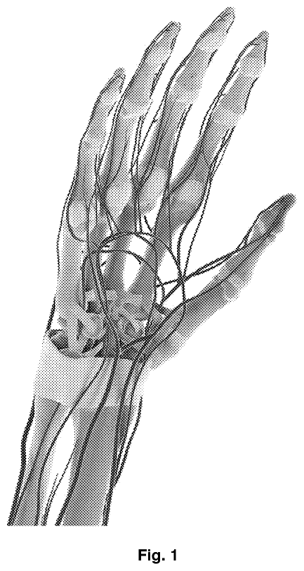

Referring to FIG. 1, the vasculature of the hand forms a continuous and interconnected network extending from the wrist, through the palm, and into the fingers, ensuring consistent perfusion across a wide range of positions and activities. Arterial inflow is primarily delivered via the radial and ulnar arteries at the level of the wrist, which give rise to dorsal and palmar carpal branches forming arterial arches across the carpal region. These vessels provide blood to the carpal bones, joints, and surrounding soft tissues, while also serving as the proximal source of blood flow into the palm.

Distal to the wrist, the arterial supply organizes into the superficial and deep palmar arches within the palm, formed predominantly by contributions from the ulnar and radial arteries. These arches give rise to palmar metacarpal arteries and common palmar digital arteries, which extend toward the fingers. As the vessels progress distally, they branch into proper digital arteries that run along the lateral aspects of each finger, ultimately forming capillary networks within the fingertips and surrounding tissues. This arrangement enables delivery of oxygenated blood to the muscles, tendons, ligaments, and skin of the hand.

Venous return mirrors this arterial architecture, with blood collected from capillary beds in the fingers into digital veins, which drain proximally into the palmar venous plexus and dorsal venous network of the hand. These venous structures converge toward the wrist, ultimately draining into the radial and ulnar veins of the forearm. The interconnections between dorsal and palmar vessels, as well as between superficial and deep systems, provide collateral pathways, enabling reliable perfusion and venous return.

The present invention broadly relates to devices for facilitating blood perfusion through the hand, including the wrist, palm, and/or fingers, and feet, including the hindfoot, midfoot, and/or forefoot. Such devices achieve this by applying mechanical pressure to one or more portions of the hand or foot (optionally in sequence) to promote blood flow through the arterial and/or venous systems. By improving blood circulation, the devices are useful for preventing tissue necrosis and amputations as a compilation of severe hypotension.

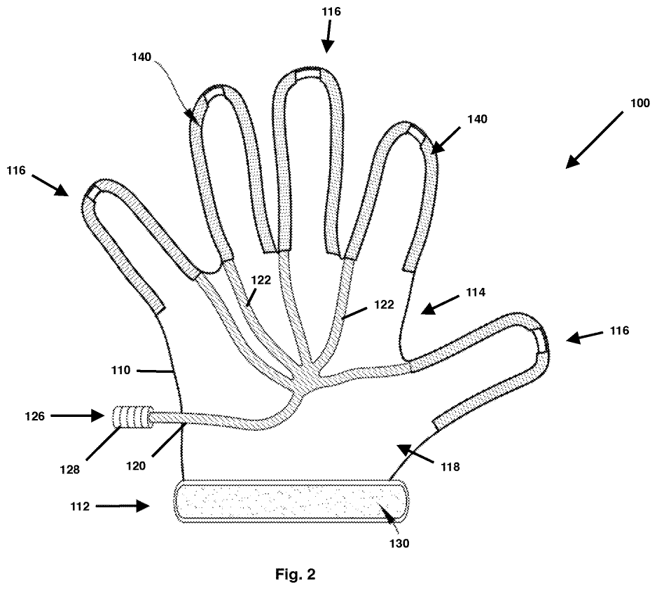

Depicted in FIG. 2 is an exemplary embodiment of the inventive device 100. Device 100 includes a glove-shaped covering 110 having a wrist portion 112, a palm portion 114, and five digit portions 116, one corresponding to each finger. Covering 110 defines an open interior space 118 configured to receive a user's hand when the device 100 is worn.

As used herein, the term “covering” refers to an exterior structure configured to be worn over at least a portion of a user's hand or foot, and which supports one or more additional components of the device (described below) in operative engagement with the user's hand or foot. The term “covering” does not require full coverage of the hand or foot; for example, embodiments configured for the hand may omit coverage of one or more fingers, the wrist, or portions of the palm.

In some embodiments, the covering may be formed from a transparent or semi-transparent material to allow an operator of the device to view the user's hand or foot while the device is in use.

In some embodiments, the covering may define fenestrations (openings, holes, or perforations) to allow airflow into and out of the interior space of the covering. Such fenestrations may be helpful for preventing moisture buildup (within the covering) and skin irritation.

In some embodiments, the covering may be fabricated as a unitary structure.

In some embodiments, the covering may be stiff and resistant to deformation under applied force, and may be formed from a rigid material, such as a stiff plastic. In other embodiments, the covering may be formed from a compliant, flexible material to facilitate donning and removal. Those skilled in the art will appreciate that a variety of plastic materials may be selected to achieve either configuration.

Referring to FIG. 1, device 100 further includes a primary conduit 120 extending through the body of covering 110 (in this embodiment, through the top along the dorsal surface of the hand) that is configured to transfer fluid (namely, air) into and out of the interior space 118. Within the palm portion, the primary conduit 120 ramifies into five branch conduits 122, each configured to transfer fluid to and from a bladder module 140 located within a digit portion 116.

In some embodiments, a chamber or plenum may be provided at the location where the conduit ramifies. Such a structure may promote more uniform distribution of fluid among the branch conduits.

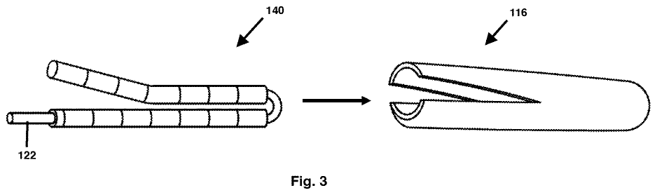

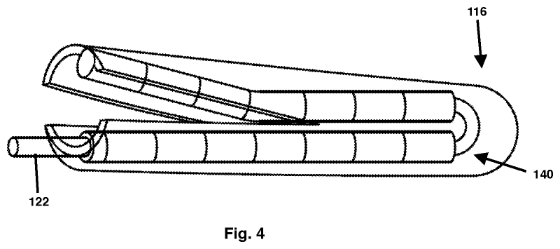

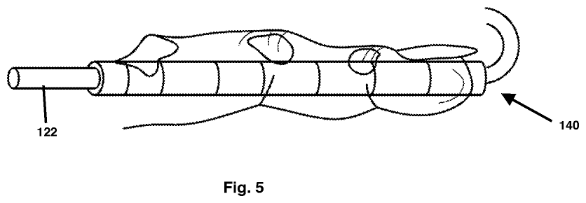

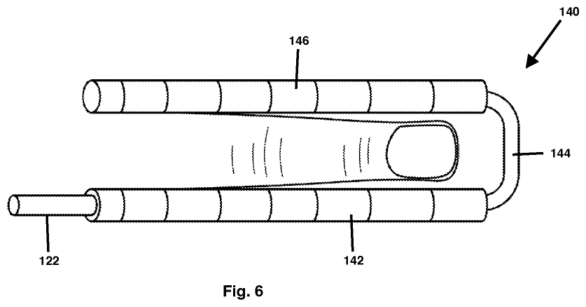

Referring to FIGS. 3-6, each bladder module 140 includes a first bladder 142 and a second bladder 146, each generally elongated and tubular in shape. The bladders 142, 146 are positioned along opposing lateral interior sides of their respective digit portions 116 and are arranged to generally align with the digital arteries and digital veins. In this configuration, each of the first and second bladders 142, 146 defines a proximal end and a distal end relative to the palm portion 114. The proximal end of the first bladder 142 is in fluid communication with a respective branch conduit 122. The distal end of the first bladder 142 is in fluid communication with a connecting conduit 144, which is further in fluid communication with the distal end of the second bladder 146. The proximal end of the second bladder 146 is closed.

The primary conduit 120 defines a main opening 126 configured to be coupled to one or more fluid transfer devices for selectively transferring fluid into and out of the primary conduit 120. In some embodiments, a single bidirectional fluid transfer device may be used; in other embodiments, multiple unidirectional devices may be employed, such as one to supply fluid and another to withdraw fluid. Any suitable coupling mechanism 128 may be used to connect the fluid transfer device(s) to the main opening 126, including, for example, a Luer Lock-type connector.

In some embodiments, the fluid transfer device may be integrated with or otherwise provided with the covering and permanently coupled to the primary conduit. The fluid transfer device may include an air compressor, a vacuum source, or a device capable of selectively operating as both. In various embodiments, counter-pulsative pumps or other devices configured to provide intermittent positive and negative pressure to the bladders may be employed. In some implementations, the covering may be coupled to a portable, battery-powered pump to facilitate transport with a patient.

In practice, the working fluid will typically be air or another gas, although liquid fluids may also be employed. An example of a suitable fluid transfer device includes some deep vein thrombosis (DVT) leg compression systems which are used to compress legs to prevent blood clots. Representative examples include the DVT Guardian available from Breg, Inc. of Carlsbad, California, the VenaPro available from Innovamed Health, LLC of San Antonio, Texas, or the PlasmaFlow available from ManaMed Inc. of Santa Ana, California. These DVT systems are typically capable of applying pressure in a range of approximately 30 to 40 mmHg.

Preferably, the magnitude, duration, and rate (of inflation and deflation) of the applied pressure are preset within the fluid transfer device(s) or another control device, such that adjustment of these parameters during use is not required.

In some embodiments, the fluid may be temperature-treated, such as by heating or cooling. A dedicated temperature-control device may be integrated with or otherwise provided as part of the covering to facilitate such treatment.

Referring to FIGS. 2-6, transferring fluid into the primary conduit 120 causes the bladder modules 140 to inflate against the covering 110. When a user's hand is inserted into the device 100, this inflation causes the bladders 142, 146 to press against the user's fingers, applying positive pressure to them. Transferring fluid out of the primary conduit 120 releases this pressure (i.e., creates negative pressure). This action (particularly when repeated as a series of pulses) helps promote blood perfusion in the user's fingers by augmenting vascular flow, including delivery of oxygenated blood to the fingers and return of deoxygenated blood into circulation.

In the embodiment of FIGS. 2-6, the first bladder 142 propels blood down the finger while the second bladder 146 propels the blood back to the palm.

In the embodiment of FIG. 2, the device further includes a hook-and-loop (e.g., Velcro) strap 130 integrated with or otherwise attached to the wrist portion 112 to help retain the device 100 on the user's hand. This is not intended to be limiting; other embodiments may employ different mechanisms for securing the covering, either in addition to or as an alternative to a hook-and-loop strap.

In the embodiment of FIG. 2, the cross-sectional area of the connecting conduit 144 is smaller than that of the bladders 142, 146. This difference increases the flow rate of fluid transferred between the first and second bladders 142, 146.

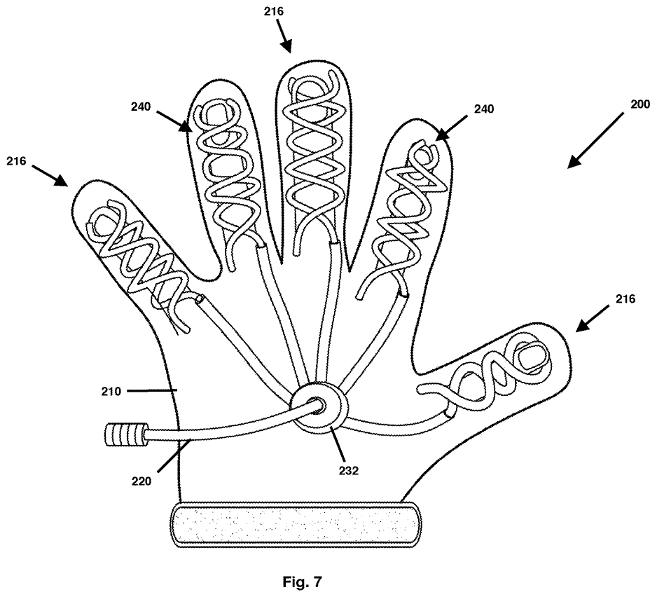

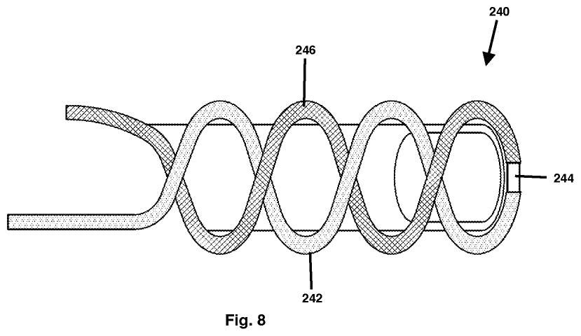

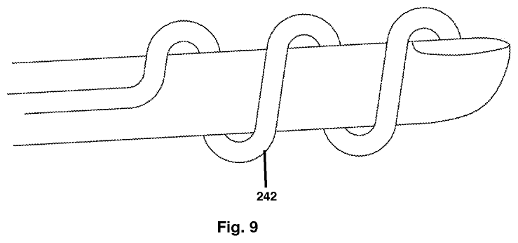

Depicted in FIGS. 7-9 is a second exemplary embodiment of the device 200. This device 200 is similar to the device of FIGS. 2-6, except that the digit portions 216 incorporate a different type of bladder module 240. Rather than running linearly alongside a finger, these bladder modules 240 include a pair of helical (spiral-shaped) bladders 242, 246 arranged such that they coil around the finger. This configuration allows the bladder module 240 to apply positive pressure along all sides of a finger, rather than only along its lateral sides. In addition, the helical bladders 242, 246 are axially offset relative one another, thereby increasing coverage along the length of the finger. As in the embodiment of FIGS. 2-6, a connecting conduit 244 fluidly couples the proximal ends of the helical bladders 242, 246.

In embodiments similar to the embodiment of FIGS. 7-9, more or fewer than two helical bladders may be provided. Varying the number of helical bladders adjusts the extent of coverage along the finger.

The embodiment of FIGS. 7-9 also includes a grommet 232 integrated into the opening of the covering 210 through which the primary conduit 220 passes. The grommet 232 reinforces the opening and helps keep the primary conduit in place.

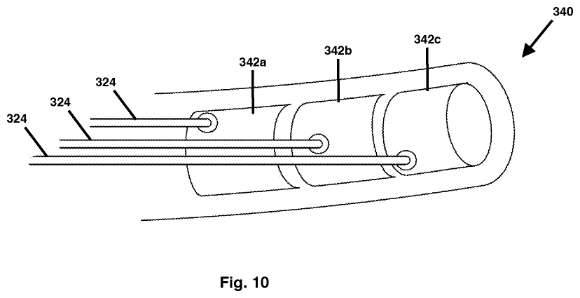

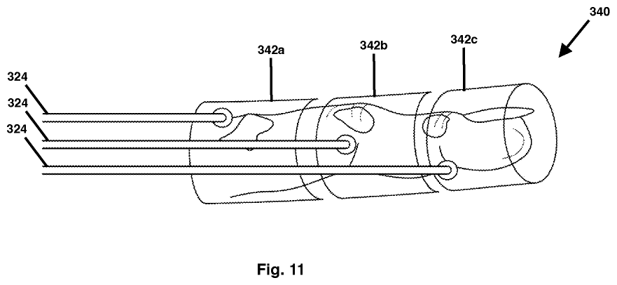

Depicted in FIGS. 10-11 is an alternative exemplary embodiment of a bladder module 340. In this embodiment, the bladder module 340 includes three circumferential bladders 342a, 342b, and 342c (collectively, circumferential bladders 342) arranged sequentially along the length of a digit, each configured to encircle a respective portion of the digit. Each circumferential bladder 342 is fluidly coupled to a corresponding dedicated conduit 324 and placed in communication with either a dedicated fluid transfer device or a fluid control/distribution manifold, thereby enabling independent inflation and deflation. This configuration permits selective application and release of pressure along discrete regions of the digit. In the embodiment of FIGS. 10-11, the circumferential bladders 342 may be actuated in a defined pattern, such as sequentially.

For embodiments incorporating the bladder module of FIGS. 10-11, a sequence such as 342a-342b-342c-342c-342b-342a may be employed. The 342a-342b-342c portion of the sequence progressively compresses the digit to encourage blood flow toward the distal tip, while the 342c-342b-342a portion progressively compresses the digit to encourage blood flow back toward the palm or midfoot.

In embodiments incorporating the bladder module 340 of FIGS. 10-11 across multiple digit portions, corresponding circumferential bladders within the sequence (i.e., similarly positioned bladders) may be fluidly coupled via a common conduit such that they inflate and deflate simultaneously. For example, all 342a circumferential bladders may be actuated together, followed by all 342b bladders, and then all 342c bladders. Alternatively, where the circumferential bladders are not fluidly coupled by a common conduit, their inflation and deflation may be temporally coordinated (e.g., via multiple fluid transfer devices or a suitable fluid control/distribution manifold) to achieve a similar simultaneous effect.

In other embodiments, bladder modules similar to that depicted in FIGS. 10-11 may include more or fewer circumferential bladders. Varying the number of circumferential bladders enables varying degrees of control over pressure application along the length of the digit.

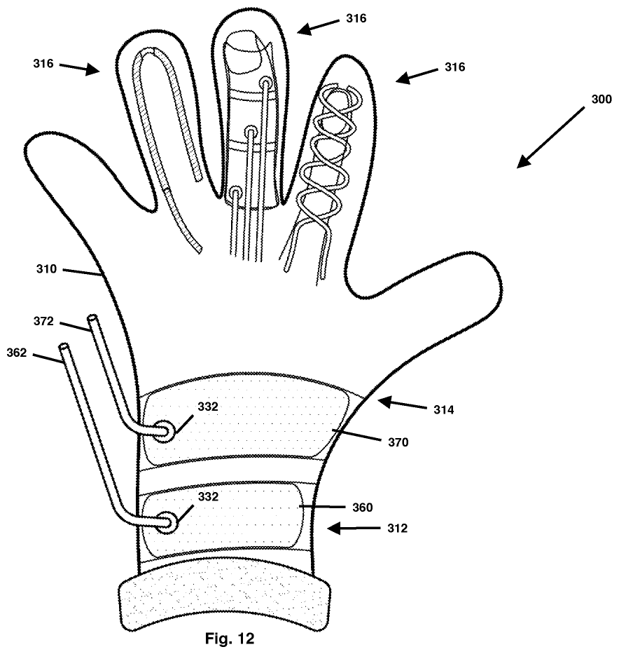

Depicted in FIG. 12 is an alternative exemplary embodiment of the device 300. This device 300 includes one of each of the bladder module types shown in FIGS. 2-6, FIGS. 7-9, and FIGS. 10-11 incorporated into three of the digit portions 316. In view of FIG. 12, it can be appreciated that more than one type of bladder module can be incorporated into any given embodiment of the device.

The device 300 of FIG. 12 further includes two additional bladders-a first bladder 360 incorporated into the proximal (relative to a user's forearm) side of the wrist portion 312 of the covering 310 and a second bladder 370 incorporated into the distal side of the wrist portion 312 extending into the palm portion 314 (located right where the wrist portion 312 and the palm portion 314 meet). These bladders 360, 370 are circumferential, configured to encircle a user's wrist and/or palm when wearing the device 300. These bladders 360, 370 are in fluid communication with conduits 362 and 372, respectively, which extend through the body of covering 310 and are held in place by grommets 332. The bladders 360, 370 operate similarly to those located in the digit portions, expanding against the covering 310 (here, the wrist portion and/or palm portion) to apply positive pressure to the user's wrist and/or palm.

Conduits 362 and 372 may be fluidly connected to the same fluid transfer device as the primary conduit used to transfer fluid to and from the bladder modules in the digit portions. Alternatively, the conduits 362, 372 may be coupled to one or more separate fluid transfer devices. In some embodiments, a manifold may be provided to control fluid flow to and from the conduits 362, 372 and the primary conduit.

With respect to the bladders disclosed herein, including those shown in FIGS. 2-6, FIGS. 7-9, and FIGS. 10-11, the bladders are configured to expand and contract as described. To facilitate such operation, the bladders may be formed from any suitable compliant material, such as an elastomeric material. In some embodiments, the bladders are configured to exhibit limited radial expansion and a relatively firm consistency, thereby promoting distribution (ideally uniform distribution) of fluid along substantially the full length of each bladder and the corresponding digit or a region thereof.

In various embodiments, the dimensions, configurations, and material compositions of the device and its associated components (including, for example, the covering, bladders, and conduits) may be selected and adjusted as needed to achieve a desired pressure profile at the user's digits. Such parameters may be selected to control the magnitude, distribution, and timing of applied pressure. In general, it is contemplated that pressures up to approximately 60-80 mmHg will be sufficient for effective operation, while pressures in a range of approximately 30-40 mmHg are preferred for promoting blood perfusion without excessive compression.

Although the embodiments disclosed herein are primarily described in the context of a hand, those skilled in the art will appreciate that the same concepts may be applied to the foot. In such embodiments, the glove-shaped covering may be replaced with a sock-shaped covering (still having one or more digit portions) configured to receive a user's foot. The bladder modules used and the arrangement thereof may be substantially the same, with corresponding modules positioned along the toes, and the configuration of conduits may likewise be similar. Operation of such embodiments would also be substantially the same, with fluid transfer used to selectively inflate and deflate the bladders to apply pressure and promote blood perfusion in the foot, including the toes.

Devices according to the present invention are not limited by overall size. Devices according to the present invention may be made larger or smaller as needed to accommodate varying hand or foot sizes. They may also be made in standard sizes (e.g., small, medium, large, extra-large, pediatric).

In some embodiments, the devices may be constructed to be disposable.

In some embodiments, the devices may be stored in sterile packaging.

While the exemplary embodiments disclosed herein and depicted in the attached figures describe the best modes known to the inventors at the time of filing, the scope of the invention is not intended to be limited to only those embodiments.

What is claimed is:

1. A device for blood perfusion comprising:
a covering comprising a digit portion, wherein:
the covering defines an open interior space wherein a distal extremity may be received;
a bladder module comprising at least one bladder, wherein:
the bladder module is located within the digit portion of the cover; and
the at least one bladder extends along at least a portion of a length of the digit module, along an inner surface thereof;
a primary conduit extending between the exterior of the covering and the interior of the covering, wherein:
the primary conduit is in fluid communication with the at least one bladder of the bladder module; and
the primary conduit comprises defines a main opening that is couplable to a fluid transfer device;
wherein the covering supports the at least one bladder of the bladder module in operative engagement with a user's digit when the device is worn; and
wherein transfer of fluid into the covering via the primary conduit causes the at least one bladder to inflate against the covering and apply positive pressure to the digit.

2. The device of claim 1, wherein:
the bladder module comprises a first bladder, a second bladder, and a connecting conduit;
each of the first bladder and the second bladder are elongated and arranged laterally along an inner surface of the digit portion;
each of the first bladder and the second bladder define a distal end and a proximal end;
the proximal end of the first bladder is connected to the primary conduit;
the connecting conduit is connected to the distal end of the first bladder and the distal end of the second bladder; and
the proximal end of the second bladder is closed.

3. The device of claim 1, wherein:
the bladder module comprises a first bladder, a second bladder, and a connecting conduit;
each of the first bladder and the second bladder is helical and arranged along an inner surface of the digit portion, extending along a length thereof, such that the first bladder and the second bladder coil around a digit when the device is worn;
each of the first bladder and the second bladder define a distal end and a proximal end;
the proximal end of the first bladder is connected to the primary conduit;
the connecting conduit is connected to the distal end of the first bladder and the distal end of the second bladder; and
the proximal end of the second bladder is closed.

4. The device of claim 1, wherein:
the bladder module comprises a plurality of circumferential bladders arranged in sequence along an inner surface of the digit portion, extending along a length thereof;
the bladder module further comprises a plurality of dedicated conduits, each separately and independently fluidly connected to a circumferential bladder; and
each dedicated conduit is in fluid communication with the primary conduit.

5. The device of claim 1, wherein:
the covering comprises a plurality of digit portions;
the device comprises a plurality of bladder modules, each located within a digit portion of the covering; and
the primary conduit ramifies into a plurality of branch conduits, each fluidly connected to a bladder module of the plurality of bladder modules.

6. The device of claim 1, wherein:
the covering is glove-shaped and configured to be worn on a hand.

7. The device of claim 1, wherein:
the covering is sock-shaped and configured to be worn on a foot.

8. The device of claim 1, wherein:
the bladder module is configured to apply pressure in a range of approximately 30 to 80 mmHg to a digit.

9. The device of claim 1, wherein:
the covering defines one or more fenestrations.

10. The device of claim 1, further comprising:
a battery-powered fluid transfer device operatively connected to the primary conduit via the main opening.
